(19) United States
(12) Patent Application Publication
(10) Pub. No.: US 2004/0139144 A1
(43) Pub. Date: Jul. 15, 2004

(54) Using web services to access computational grids by non-members of the grid

(76) Inventors: Virinder M. Batra, Chapel Hill, NC (US); Steven M. Miller, Cary, NC (US); Keith J. Purcell, Willow Spring, NC (US)

Correspondence Address: Joseph M. Imhof, Esquire, Synnestvedt & Lechner, 2600 Aramark Tower, 1101 Market Street, Philadelphia, PA, 19107-2950, US

(21) Appl. No.: 10/335,812

(22) Filed: Dec. 31, 2002

(51) Int. Cl. G06F 15/16

(52) U.S. Cl. 709/200

(57) ABSTRACT

A method, system, and computer program product for allowing a non-member device to access a computational grid. A set of web services is created to provide a port through which a user can access a computational grid using a non-member device. The web services are created using an XML based workflow definition language, such as Web Services Flow Language (WSFL) to provide access to one or more computational grids. A server accepts a user request via a web browser, uses the XML based workflow definition language such as WSFL to create a web service to identify the correct grid or grids that would provided the requested resource, identify an available member of the chosen grid, and create a request that can be processed by the grid member operating within the grid protocols. Once the grid member has obtained the requested solution, the solution is returned to the web service and then supplied to the non-member device.

### FIELD OF THE INVENTION

The present invention relates to access to computer resources. More particularly, it relates to access to computational grids by devices that are not members of the grid.

### BACKGROUND OF THE INVENTION

Grid technology enables a large scale sharing of computer resources located at remote locations. Computational grids are networks of many computers, often numbering in the thousands, that all have the ability to participate in a solving a single problem simultaneously. Unlike conventional computer networks that focus on communication among users, grid computing is directed at harnessing unused processing cycles of all the computers within the grid to solve problems that require more computing resources than could be provided on any single machine. A well known example of a computational grid is the Search for Extraterrestrial Intelligence (SETI) project. SETI shares the unused processor cycles of thousands of computers to perform the vast amount of processing that is performed upon radio signals received from outer space in the search for intelligent life.

While SETI is likely the most well known computational grid, grid technologies can be used in any area where it is necessary to perform a large number of operations or access a large volume of data. Grid computing has become a growing area of computer technology in recent years because of the advantages it offers. It provides a cost-effective use of existing computer resources. It offers a way to solve problems that require an enormous amount of computing power. Computational grids also suggest that the resources of many computers can be cooperatively managed to work toward a common objective. For these reasons, it is anticipated that the use of computational grids will increase significantly in the near future.

While there exists substantial advantages in using computational grids, access to existing grids is limited. In order to access information or computer resources contained within a computational grid, a user needs to have access to a computer that is contained within the grid. Such a device is referred to as a grid member. Any computer device that is not a part of the computational grid is referred to as a non-member device.

Limited access to grid resources poses a significant obstacle to the expansion of the use of computational grids. Currently, it is not possible for a non-member device to obtain access to a computational grid. Computational grids require member devices to be capable of communicating with the grid. Protocols such as Grid Information Protocol (GRIP) and Grid Registration Protocol (GRRP) have been developed to allow member devices to access information contained within the grid. However, it is not possible for non-member devices that are not capable of communicating in accordance with the grid protocols to access and use the grid resources. As a result, a user who desires to access a computational grid must do so via a member device, which might not be located nearby to the user's location.

Accordingly, there is a need for developing a system to allow someone who requires access to information contained within a computational grid to access the grid via a non-member device. The present invention fulfills this need among others.

### SUMMARY OF THE INVENTION

The present invention provides a method, system, and computer program product for allowing a non-member device to access a computational grid. In accordance with the present invention, a set of web services is created to provide a port through which a user can access a computational grid using a non-member device. The web services are created using an XML based workflow definition language, such as Web Services Flow Language (WSFL) to provide access to one or more computational grids. A server accepts a user request via a web browser, uses the XML based workflow definition language such as WSFL to create a web service to identify the correct grid or grids that would provide the requested resource, identify an available member of the chosen grid, and create a request that can be processed by the grid member operating within the grid protocols. Once the grid member has obtained the requested solution, the solution is returned to the web service and then supplied to the non-member device. Alternatively, the web service can inform the member device of the location of the non-member device as part of the request, and the member device can then communicate directly with the non-member device. Furthermore, once the web service has been created using WSFL, subsequent similar requests can invoke the previously created web service, thus eliminating the need to create a new web service for a specific request.

One aspect of the present invention is a web service which accepts requests for a computational grid solution in HTTP Post format and creates a request that can be sent to a grid member in the form of a SOAP envelope. The web service determines the location of the requested solution with one or more computational grids, and sends the SOAP envelope to the appropriate grid member, in accordance with WSFL. The SOAP envelope can be processed by the member and the solution is returned to the web service via a second SOAP envelope. The web service reads the returned SOAP envelope and returns the results to the non-member device via an HTTP command.

### BRIEF DESCRIPTION OF THE DRAWINGS

FIG. 1 is flow chart of the steps used to access a computational grid by a non-member device in accordance with the present invention.

FIG. 2 is a diagram showing a system operating in accordance with the present invention.

FIG. 3 is a diagram showing a system operating in accordance with an alternate embodiment of the present invention.

### DETAILED DESCRIPTION OF THE INVENTION

The present invention described herein is a system that allows for access to computational grids by non-member devices. In a preferred embodiment, a user desires to obtain a solution from one or more computational grids but does not have access to a grid member.

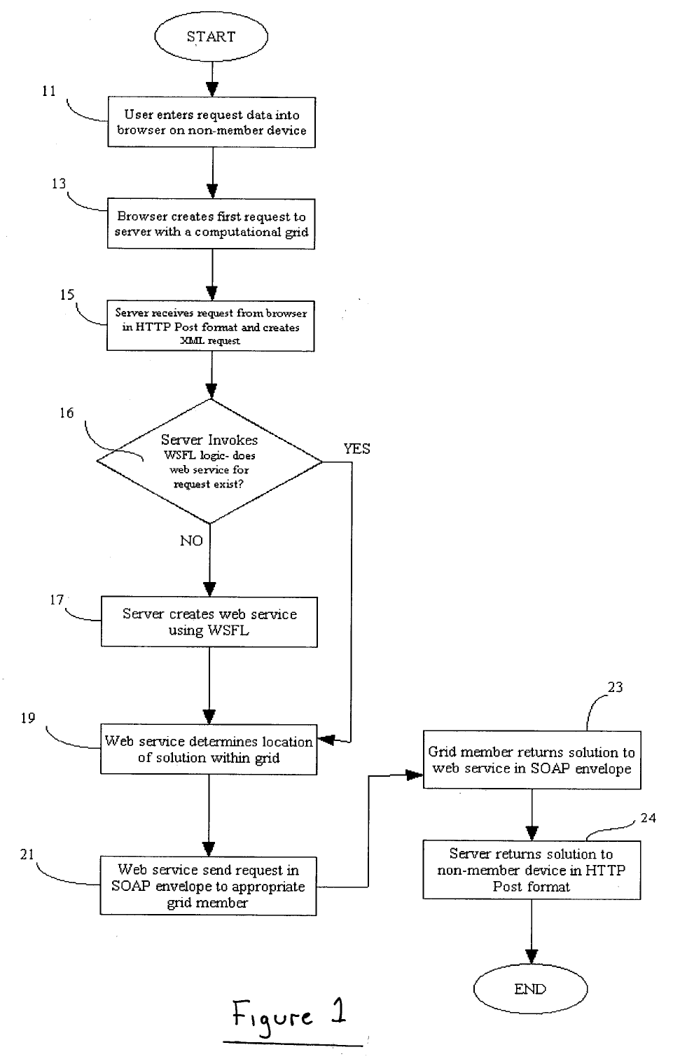

FIG. 1 is a flowchart illustrating the steps used to access a computational grid by a non-member device in accordance with the present invention. Referring to FIG. 1, a user first enters a desired request into a non-member device running a web browser (step 11). For example, a doctor in a hospital might desire to obtain prescription information comprised of data stored by a plurality of pharmaceutical companies. In this example, the pharmaceutical companies are all operating within a computational grid; however, the computers located at the hospital where the subject doctor resides are not members of the grid. The doctor enters the information he is seeking into the browser operating on a non-member device at the hospital. Preferably, this is accomplished using an XML form designed to operate with the web service to which the request is submitted. The creation and use of XML forms is well known technology and is not discussed further herein.

Once the user request has been defined, it is sent to a server operating on a host computer that is a member of one or more computational grids (step 13). In the example set forth above, the computational grid would likely be a grid comprised of data centers located at various pharmaceutical companies. Preferably, the user defined request comprises an HTTP Post command, although other formats could also be used. The server receives the HTTP Post command, and uses the data contained within the HTTP Post command to create an XML request for the required solution, preferably using a SOAP envelope, although other XML formatted languages could also be used (step 15).

The server invokes an XML-based workflow definition grammar to determine if a web service has previously been created to obtain the solution for the particular query received (step 18). If the desired web service does not exist, the server implements the XML based workflow definition grammar to create the desired web service (step 17). Preferably, the XML based workflow definition grammar used is Web Services Flow Language (WSFL) developed by IBM (Aramonk, N.Y.). However, alternative embodiments can use XLANG (eXtensible LANGuage by Microsoft), ebXML (Electronic Business using eXtensible Markup Language sponsored by UN/CEFACT and OASIS), Business Process Modeling Language, or Web Services Conversation Language.

If the desired web service was previously created by a prior request, the server invokes the existing web service. The web service uses WSFL to read the SOAP envelope and determines the location and availability of the solution on a particular computational grid. The web service can search a plurality of available grids using a WSFL web service composition. The available grids are those grids of which the web service is a member, and can comprise any number of computational grids. WSFL allows for communication between the web service and one or more computational grids. WSFL provides a prototype for communication between the computational grids and the user's web browser. Elements such as PlugLinks define the relation between a user's browser and a particular computational grid. A ControlLink is established to prescribe the order in which the flow of information between the web service and the grid member occurs. A full disclosure of the parameters of WSFL can be found in “Web Services Flow Language 1.0” by Prof. Dr. Frank Leymann of the IBM Software Group, which is incorporated herein by reference. However, the operation of WSFL and the various other workflow definition grammars are known to those of skill in the art.

The web service takes the information provided within the SOAP envelope and searches the available computational grids to determine if the desired solution resides within the grid, and if so, at what location (step 19).

Once the location of the desired solution has been determined, the web service communicates with the computational grid member to obtain the solution (step 21). The web service obtains the solution from the grid member and sends the solution back to the server in the form of a second SOAP envelope (step 23). The server receives the second SOAP envelope, and returns the solution to the browser of the non-member device in HTTP Post format (step 24).

If the particular query from the user was a novel query, the information flow established is saved as a new web service to facilitate future connections from the user to the grid member.

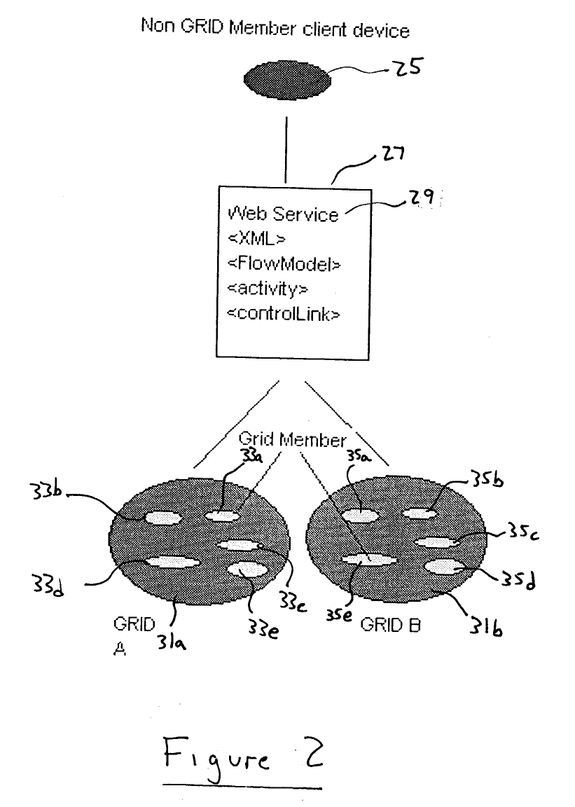

FIG. 2 illustrates the relationship between the web service operating in accordance with the present invention and the surrounding environment. The user accesses the system via a non-member device 25. The non-member device 25 uses a web browser to access a server 27 running a web service 29. Alternatively, the server 27 might not host the web service 29, but instead might invoke it from a remote location. The web service 29 residing on the server 27 communicates with at least one computational grid 31a, 31b containing a plurality of grid members 33a, 33b, 33c, 33d, 33e, 35a, 35b, 35c, 35d, 35e. Once a grid member containing the solution is identified and the solution is obtained, the solution is returned to the server via the web service. The server returns the solution to the non-member device, preferably using an HTTP Post format.

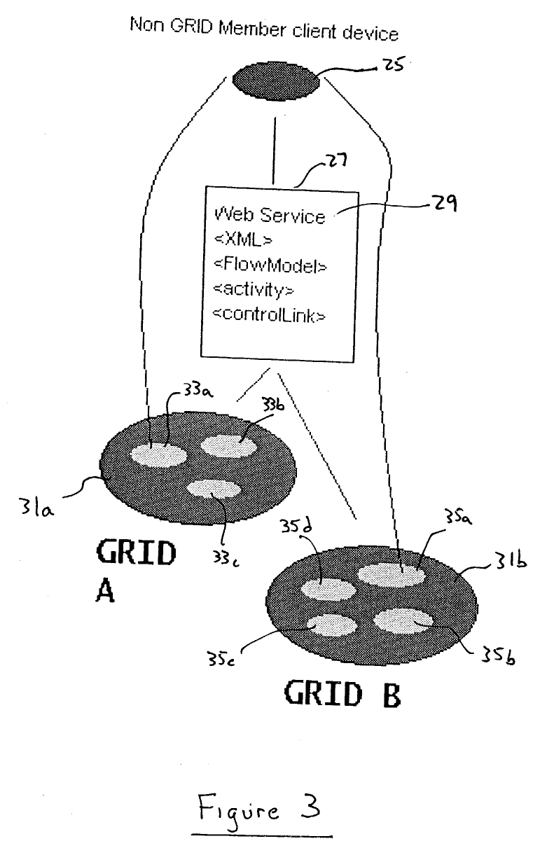

An alternative embodiment is shown in FIG. 3. Referring to FIG. 3, the user accesses the system via a non-member device 25. The non-member device 25 uses a web browser to access a server 27 containing a web service 29. The web service communicates with one or more computational grids 31a, 31b containing a plurality of grid members 33a, 33b, 33c, 35a, 35b, 35c, 35d. However, in the embodiment shown in FIG. 3, the web service uses WSFL to communicate the location of the original non-member device 25 to the grid member containing the solution to the original request. The grid member 33a, 35a then returns the solution directly to the browser of the non-member client device 25, preferably using HTTP Post. Once communication has been facilitated between the proper grid member and the non-member device, it is no longer necessary to rout the solution back through the web service. This enables the response time to the request from the non-member device to be minimized.

Additionally, in the embodiment shown in FIG. 3, once the web service has located the proper location within the grid where the solution can be found and identified the browser to the grid member, the user can send additional requests from the non-member device 25 directly to the grid member (for example, 35a) without having to invoke the web service. This increases the speed and efficiency of the processing of subsequent requests.

Using a web service that implements WSFL or another XML based workflow definition grammar to enable a non-member device to access a computational grid allows the vast resources contained within computational grids to become available to users all over the world. It enables users to access resources via the internet which were previously unavailable to anyone who did not have local access to a device that is a member of the grid. It also provides a means for a user to find a solution contained within a particular computational grid without having to know which computational grid contains the solution. Using a web service to facilitate the communication between a grid member and a non-member device provides an efficient means to realize these objectives.

Software programming code which embodies the present invention is typically stored in permanent storage of some type, such as the permanent storage of a workstation in computer grid. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

The above-described steps can be implemented using standard well-known programming techniques. The novelty of the above-described embodiment lies not in the specific programming techniques but in the use of the steps described to achieve the described results.

It should be understood that the foregoing is illustrative and not limiting and that obvious modifications may be made by those skilled in the art without departing from the spirit of the invention. Accordingly, the specification is intended to cover such alternatives, modifications, and equivalence as may be included within the spirit and scope of the invention as defined in the following claims.

We claim:

1. A method for providing access to a computational grid by a non-member device, comprising the steps of:
1) providing a first request from said non-member device;
2) sending said first request to a server operating within at least one computational grid;
3) invoking a web service by said server that implements an XML workflow definition grammar;
4) sending a second request from said web service to a grid member of said at least one computational grid;
5) processing a solution by said grid member; and
6) returning said solution to said non-member device.

2. The method as set forth in claim 1, wherein step 3 further comprises the steps of:
3.1) determining if a web service exists for said first request;
3.2) creating a new web service using an XML workflow definition grammar if a web service for said first request does not currently exist; and
3.3) invoking said new web service.

3. The method as set forth in claim 1, wherein step 6 further comprises the steps of:
6.1) returning said solution to said server via the web service; and
6.2) returning said solution to said non-member device from said server.

4. The method as set forth in claim 3, wherein step 6.1 comprises returning said solution to said server using a SOAP envelope.

5. The method as set forth in claim 3, wherein step 6.2 comprises returning said solution to said non-member device in the form of an HTTP Post.

6. The method as set forth in claim 1, wherein step 4 further comprises the steps of:
4.1) selecting a single grid from said at least one grids;
4.2) determining the individual grid member within said single grid that contains said solution; and
4.3) sending said second request to said individual grid member.

7. The method as set forth in claim 1, wherein said first request is an HTTP Post request.

8. The method as set forth in claim 1, wherein XML workflow definition grammar used by said web service is WSFL.

9. The method as set forth in claim 1, wherein said second request is formatted as a SOAP envelope.

10. The method as set forth in claim 1, wherein said web service resides on said server.

11. A system for providing access to a computational grid by a non-member device, comprising:
means for providing a first request from a non-member device;
means for sending said first request to a server operating with at least one computational grid;
means for invoking a web service by said server implementing an XML workflow definition grammar;
means for sending a second request from said web service to a grid member of said at least one computational grid;
means for processing a solution by said grid member; and
means for returning said solution to said non-member device.

12. The system as set forth in claim 11, wherein said means for invoking a web service further comprises:
means for determining if a web service exists for said first request; and
means for creating said web service if said web service does not currently exist.

13. The system as set forth in claim 11, wherein said means for returning said solution to said non-member device further comprises:
means for returning said solution to said server via said web service; and
means for returning said solution from said server to said non-member device.

14. The system as set forth in claim 11, wherein means for sending said second request from said web service to a grid member further comprises:
means for selecting a single grid from said at least one grids;
means for determining the individual grid member within said single grid that contains said solution; and
means for sending said second request to said individual grid member.

15. The system as set forth in claim 11, wherein said XML workflow definition grammar used by said web service is WSFL.

16. The system as set forth in claim 11, wherein said web service resides on said server.

17. A computer program product recorded on computer readable medium for providing access to a computational grid by a non-member device, comprising:
computer readable means for providing a first request from a non-member device;
computer readable means for sending said first request to a server operating with at least one computational grid;
computer readable means for invoking a web service by said server implementing an XML workflow definition grammar;
computer readable means for sending a second request from said web service to a grid member of said at least one computational grid;
computer readable means for processing a solution by said grid member; and
computer readable means for returning said solution to said non-member device.

18. The computer program product as set forth in claim 17, wherein said computer readable means for invoking a web service further comprises:
computer readable means for determining if a web service exists for said first request; and
computer readable means for creating said web service if said web service does not currently exist.

19. The computer program product as set forth in claim 17, wherein said computer readable means for returning said solution to said non-member device further comprises:
computer readable means for returning said solution to said server via said web service; and
computer readable means for returning said solution from said server to said non-member device.

20. The system as set forth in claim 17, wherein the computer readable means for sending said second request from said web service to a grid member further comprises:
computer readable means for selecting a single grid from said at least one grids;
computer readable means for determining the individual grid member within said single grid that contains said solution; and
computer readable means for sending said second request to said individual grid member.

21. The system as set forth in claim 17, wherein said XML workflow definition grammar used by said web service is WSFL.
